(19) United States
(12) Patent Application Publication
(10) Pub. No.: US 2024/0070749 A1
(43) Pub. Date: Feb. 29, 2024

(54) CONTENT RECOMMENDATION USING ARTIFICIAL INTELLIGENCE

(71) Applicant: Royal Bank of Canada, Toronto (CA)

(72) Inventors: Kexin CHEN, Toronto (CA); Madelyn Johnston, Mississauga (CA); Dongwoo Kang, Toronto (CA); Brian Nguyen, Toronto (CA); Hannah Boulakia, Toronto (CA); Alex Brandimarte, Toronto (CA); Viktor Iakovenko, Vaughan (CA); Behrad Borhani, Vaughan (CA); Sarah Spear, Toronto (CA)

(21) Appl. No.: 18/237,217

(22) Filed: Aug. 23, 2023

Related U.S. Application Data
(60) Provisional application No. 63/400,657, filed on Aug. 24, 2022.

(51) Int. Cl. G06Q 30/0601

(52) U.S. Cl. CPC G06Q 30/0631

(57) ABSTRACT

The present disclosure describes an artificial intelligence approach to digital content recommendation where the recommendation mechanics differ based on the amount of information available. In one aspect, a user is identified as an above-threshold user who has consumed at least a threshold number of digital artifacts or a below-threshold user who has consumed fewer digital artifacts and different recommendation engines are used for above-threshold users and below-threshold users. In another aspect, users are bifurcated into low-data users and high-data users. For high-data users, digital artifacts are directly selected, and for low-data users, digital artifacts are indirectly selected by first selecting a digital artifact property criteria and then selecting digital artifacts that satisfy the selected digital artifact property criteria. In another aspect, digital artifacts are selected according to a common recommendation engine, wherein a quantity of digital artifacts consumed by the user is an input to the common recommendation engine.

### CROSS-REFERENCE TO RELATED APPLICATIONS

This application claims priority to U.S. Provisional Patent Application No. 63/400,657 filed on Aug. 24, 2022, which is incorporated herein by reference.

### TECHNICAL HELD

The present disclosure is directed toward artificial intelligence, and more specifically to using artificial intelligence to recommend relevant digital artifacts.

### BACKGROUND

There is a wide range of digital media content available for consumption. There are literally millions of articles, podcasts, songs, videos, books, images, and other media available in digital form. There are a number of mechanisms for recommending digital media content, including human curation and artificial intelligence approaches, ranging from primitive procedural mechanisms (e.g. “recommend more books from the same author”) to sophisticated machine learning techniques. While many of the more sophisticated methods can make good recommendations where there is sufficient data about the user for whom the recommendation is to be made, making good recommendations is challenging in the case of new users for whom there is little or no available data.

### SUMMARY

Broadly speaking, the present disclosure describes an artificial intelligence approach to recommendation of relevant digital content in which the recommendation mechanics differ based on the amount of information available for the user for whom the recommendation is made.

In one aspect, a computer-implemented method for selecting digital artifacts for recommendation from amongst a plurality of digital artifacts comprises identifying a current user as one of an above-threshold user who has consumed at least a threshold number of digital artifacts, and a below-threshold user who has consumed fewer than the threshold number of digital artifacts. Where the current user is identified as being an above-threshold user, the method selects digital artifacts for recommendation according to a first recommendation engine, and where the current user is identified as being a below-threshold user, the method selects digital artifacts for recommendation according to a second recommendation engine.

In one embodiment, the first recommendation engine is an artifact-centric recommendation engine and the second recommendation engine is a property-centric recommendation engine. In a particular embodiment, the artifact-centric recommendation engine deploys an artifact-centric collaborative filtering engine that selects the digital artifacts for recommendation by comparing the current user to similar prior users. In a particular embodiment, the property-centric recommendation engine further identifies each current user who was identified as a below-threshold user as one of an empty user who has consumed no digital artifacts, and a naïve user who has consumed at least one digital artifact and fewer than the threshold number of digital artifacts. In this particular embodiment, for each current user who is identified as being a naïve user, the property-centric recommendation engine deploys a property-centric collaborative filtering engine that selects digital artifact property criteria by comparing the current user to similar prior users. In one instance of this particular embodiment, for each current user who is identified as being an empty user, the property-centric recommendation engine receives user input from the empty user wherein the user input is indicative of areas of interest to the empty user and selects the digital artifact property criteria according to the user input. The property-centric recommendation engine may select the digital artifacts for recommendation from amongst a set of digital artifacts satisfying the selected digital artifact property criteria according to at least one of a relevance score, a release time, and randomness. The digital artifact property criteria may be a topic determined by Latent Dirichlet Allocation (LDA) topic modeling.

In another aspect, a computer-implemented method for selecting digital artifacts for recommendation from amongst a plurality of digital artifacts comprises bifurcating users into low-data users and high-data users. For the high-data users, the method directly selects individual ones of the digital artifacts for recommendation according to a first recommendation engine, and for the low-data users, the method indirectly selects individual ones of the digital artifacts for recommendation by first selecting a digital artifact property criteria and then selecting from among those of the digital artifacts that satisfy the selected digital artifact property criteria.

In one embodiment, the first recommendation engine is a first collaborative filtering engine.

In one embodiment, the method further bifurcates the low-data users into zero-data users and some-data users, and for the some-data users, selects the digital artifact property criteria using a second recommendation engine. The second recommendation engine may be a second collaborative filtering engine. The method may further comprise, for the zero-data users, receiving user input from the zero-data users, wherein the user input is indicative of areas of interest, and selecting the digital artifact property criteria according to the user input.

In another aspect, a computer-implemented method for recommending digital artifacts from amongst a plurality of digital artifacts comprises selecting, for a particular user, digital artifacts for recommendation according to a common recommendation engine, wherein a quantity of digital artifacts consumed by the user is an input to the common recommendation engine.

In other aspects, the present disclosure is directed to data processing systems and computer program products for implementing the above-described methods.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 shows a computer network that comprises an example embodiment of a system for using machine learning to recommend relevant digital content;

FIG. 2 depicts an example embodiment of a server in a data center;

FIG. 3 shows a first illustrative embodiment of a computer-implemented method for selecting digital artifacts for recommendation from amongst a plurality of digital artifacts;

FIG. 4 is a flow chart showing the method of FIG. 3;

FIG. 5 shows a second illustrative embodiment of a computer-implemented method for selecting digital artifacts for recommendation from amongst a plurality of digital artifacts;

FIG. 5A shows an illustrative computer-implemented method for selecting digital artifacts for recommendation by a property-centric recommendation engine as an aspect of the method shown in FIG. 5;

FIG. 5B shows a modified form of the arrangement shown in FIG. 5A;

FIG. 6 is a flow chart showing the method of FIG. 5;

FIG. 6A is a flow chart showing the method of FIG. 5A;

FIG. 7 shows an illustrative process flow diagram for recommendation of digital artifacts; and

FIG. 8 is a block diagram showing an illustrative architecture for a system for selecting digital artifacts for recommendation from amongst a plurality of digital artifacts.

FIG. 9 shows a method in which a trained machine learning model is used as a common recommendation engine that can select digital artifacts for recommendation from amongst a plurality of digital artifacts using a quantity of digital artifacts consumed as input.

### DETAILED DESCRIPTION

Broadly speaking, the present disclosure describes a system, method and computer program product to use machine learning to recommend relevant digital content.

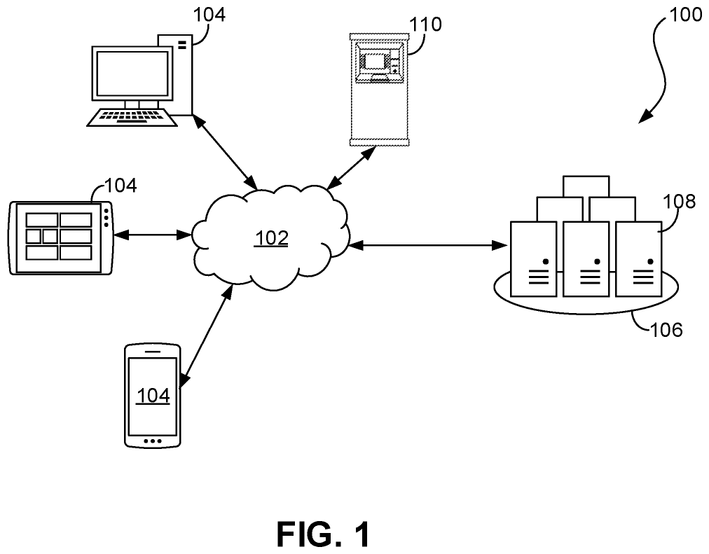

Referring now to FIG. 1, there is shown a computer network 100 that comprises an example embodiment of a system for using artificial intelligence to recommend relevant content. More particularly, the computer network 100 comprises a wide area network 102 such as the Internet to which various client devices 104, an automated teller machine (ATM) 110, and data center 106 are communicatively coupled. The data center 106 comprises a number of servers 108 networked together to collectively perform various computing functions. For example, in the context of a financial institution such as a bank, the data center 106 may host online banking services that permit users to log in to those servers using user accounts that give them access to various computer-implemented banking services, such as online fund transfers; the users may also be provided with access to e-mail services and/or various types of content. One or more of the servers 108 may implement a method for selecting digital artifacts for recommendation from amongst a plurality of digital artifacts; users may access the digital artifacts using the client devices 104. The digital artifacts may be stored on servers 108 in the data center 106, or elsewhere. Furthermore, individuals may appear in person at the ATM 110 to withdraw money from bank accounts controlled by the data center 106. The ATM 110 may in some embodiments be configured to provide access to certain types of digital artifacts, for example short articles or videos.

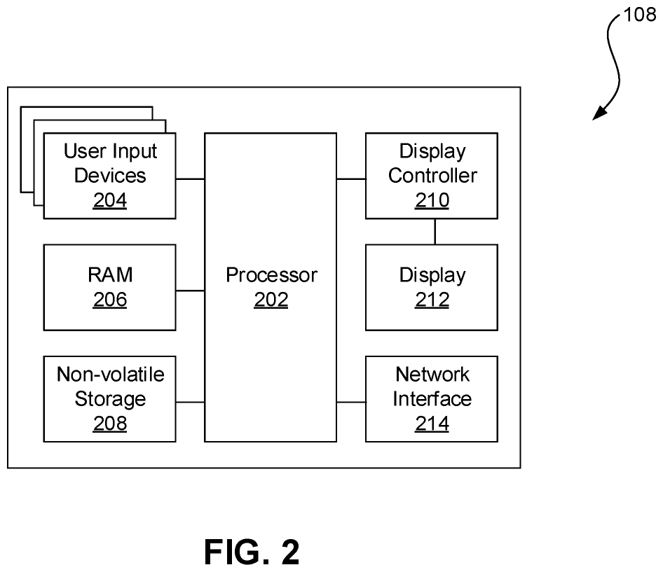

Referring now to FIG. 2, there is depicted an example embodiment of one of the servers 108 that comprises the data center 106. The server comprises a processor 202 that controls the overall operation of the server 108. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the processor 202 at runtime; a display controller 210, which is communicatively coupled to and controls a display 212; and a network interface 214, which facilitates network communications with the wide area network 102 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to implement methods for selecting digital artifacts for recommendation as described in more detail below. Additionally or alternatively, the servers 108 may collectively perform that method using distributed computing. While the system depicted in FIG. 2 is described specifically in respect of one of the servers 108, analogous versions of the system may also be used for the client devices 104.

The present disclosure describes various computer-implemented methods for selecting digital artifacts for recommendation from amongst a plurality of digital artifacts. The term “digital artifact”, as used herein, refers to a discrete unit of human-comprehensible digital media content that a human user can engage with, and includes, for example, digital documents such as books, book chapters, articles, web pages, digital audio media such as music (e.g. songs) and podcasts, digital images (still or animated), digital video (with and without associated audio), and games. The term “digital artifact” includes a digital representation of a financial product, such as a stock, stock option, bond, currency, cryptocurrency, commodity, commodity option, etc. and a digital representation of a service, like an airline flight or a concert ticket. The term “digital artifact” may also include a digital representation of a physical item, such as a web page listing a product for sale, or available by redeeming reward points. The physical item represented by a digital artifact may be a unique item (e.g. a Faberge egg, a graded copy of Action Comics #1, or a personal letter signed by famous economist Dr. Thomas Sowell), a semi-unique item (e.g. a limited edition print), or a non-unique item (e.g. a mass produced product like a box of waffle mix). A “digital artifact” may also represent a goods/services hybrid, such as a restaurant meal, or painting of a portrait. Of note, a digital artifact may comprise only a single digital file, or may comprise a plurality of digital files that cooperate to form the digital artifact. For example, a web page may include text, image, and cascading style sheet (CSS) files that cooperate as a single digital artifact. Also of note, as used herein the term “digital artifact” does not refer to unintended or undesired alteration of data by a digital process as in for example digital video or digital image editing.

Digital artifacts will have various properties. For example, a book may have properties such as author, title, various categories (e.g. fiction or non-fiction), genres (e.g. romance, thriller, textbook, etc.), publication date, series, length (words/pages), etc. The properties of a digital artifact may include objective properties (e.g. number of words in a book) and subjective properties (e.g. there may be some subjectivity as to whether a particular movie is a “thriller” or an “action movie”, or both). Properties of digital artifacts may include annotations, for example one or more conceptual “topic” annotations can be abstracted from the title and/or content of an article.

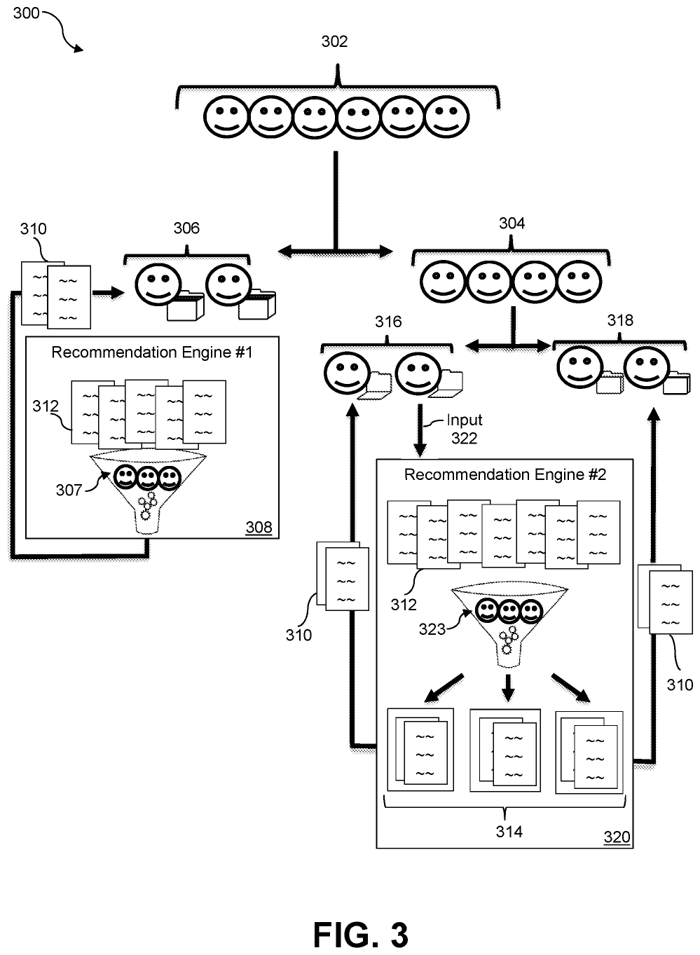

Reference is now made to FIG. 3, which shows a first illustrative embodiment of a computer-implemented method 300 for selecting digital artifacts for recommendation from amongst a plurality of digital artifacts. According to the method 300, a plurality of users 302 are bifurcated into low-data users 304 and high-data users 306. The low-data users 304 are those for whom a computer system implementing the method 300 has not yet accrued a threshold level of data. For example, the threshold may be a number of digital artifacts viewed or otherwise engaged with by a user 302, or a number of digital artifacts that have been subject to an action by the user, such as a “like” or “dislike” or a “share”, or some other suitable action. The high-data users 306 are those for whom the computer system implementing the method 300 has accrued at least the threshold level of data. Typically, the threshold will be set based on an amount of data that is sufficient to support inferences by a machine learning model about user preferences in respect of specific digital artifacts; the threshold may differ based on the model used. The bifurcation may be carried out by a computer system implementing the method 300.

For the high-data users 306, a first recommendation engine 308 directly selects individual digital artifacts 310 from among a plurality of digital artifacts 312 for recommendation to the high-data users 306. For example, where the digital artifacts are books, the first recommendation engine 308 directly selects individual books from among a plurality of books for recommendation to the high-data users 306.

The first recommendation engine 308 may be a suitably trained machine learning model, for example a trained neural network. In one embodiment, the first recommendation engine 308 is a first collaborative filtering engine. Collaborative filtering is a machine learning technique that can filter out items that may be of interest to a user based on reactions by similar users. In collaborative filtering, data about a particular user is leveraged to identify other users of the system having similar proclivities or affinities, and then items that were of interest to those similar users can be recommend to the particular user. For example, consider a particular user (“User 1”) who has engaged with certain books, where a first collaborative filtering engine has identified shared proclivities and affinities with other users, in this case “User 2”, “User 3”, and “User 4”. Previous book purchases for User 1, User 2, User 3, and User 4 are shown in the table below:

TABLE 1
Recommendation of Digital Artifacts

| | User 1 | User 2 | User 3 | User 4 |
|---|---|---|---|---|
| “Economics in One Lesson” | X | | | X |
| “Basic Economics” | ? | X | X | X |
| “Do the Right Thing: The People's | | X | X | |
| Economist Speaks” | | | | |
| “How an Economy Grows and | X | X | | X |
| Why it Crashes” | | | | |

In this context, since similar users (User 2, User 3, and User 4) have shown interest in “Basic Economics” (by Dr. Thomas Sowell, referenced above), the first collaborative filtering engine will likely recommend “Basic Economics” to User 1.

Thus, where the first recommendation engine 308 is a first collaborative filtering engine, data about a particular one of the high-data users 306 is used to identify other users 307 of the system having similar proclivities or affinities, and then digital artifacts 312 that were of interest to those similar users 307 can be recommended to the particular one of the high-data users 306.

As noted above, the first recommendation directly selects individual digital artifacts 310 from among a plurality of digital artifacts 312 for recommendation. Thus, in the above non-limiting illustrative example where the digital artifacts are books, the first recommendation engine 308 directly selects individual books (e.g. “Basic Economics”) from among a plurality of books (e.g. other books about economics) for recommendation to the high-data users 306.

For the low-data users 304, individual digital artifacts 310 are indirectly selected for recommendation to the low-data users 304 by first selecting a digital artifact property criteria 314 and then selecting from among the plurality of digital artifacts 312 those individual digital artifacts 310 that satisfy the selected digital artifact property criteria 314. The term “criteria”, as used herein, is deemed to include both the singular “criterion” as well as the plural “criteria”. The digital artifact property criteria 314 may be one or more properties of the digital artifacts. For example, where the digital artifacts are books, the digital artifact property criteria may be the author, or may be a combination of two properties (e.g. non-fiction and history) or more than two properties.

In the illustrated embodiment, the method 300 further bifurcates the low-data users 304 into zero-data users 316 and some-data users 318. The zero-data users 316 are those for whom the computer system implementing the method 300 has not yet accrued any data for supporting inferences about the user's specific digital artifact preferences, for example first time users of the computer system implementing the method 300. The some-data users 318 are those for whom the computer system implementing the method 300 has accrued some data for supporting inferences about the user's specific digital artifact preferences, but less than the threshold level of data.

For the some-data users 318, there may be sufficient information to identify digital artifact property criteria for digital artifacts in which the some-data users 318 may be interested, but not enough to reliably identify specific digital artifacts of likely interest. In the illustrated embodiment, for the some-data users 318, the digital artifact property criteria 314 will be selected using a second recommendation engine 320, which may be a second collaborative filtering engine that uses the limited data available for the some-data users 318. For example, if the digital artifacts are books, there may be enough data to select a general class of books (e.g. medieval fiction) for a particular some-data user 318, but insufficient data to recommend specific books. Thus, the class “medieval fiction” is one example of a digital artifact property criteria. In the case where the second recommendation engine 320 is a second collaborative filtering engine, consider a particular user (“User 5”), where the second collaborative filtering engine has identified shared proclivities and affinities with other users, in this case “User 6”, “User 7”, and “User 8”. Previous digital artifact property criteria identified for User 5, User 6, User 7, and User 8 are shown in the table below:

TABLE 2
Recommendation of Digital Artifact Property Criteria

| | User 5 | User 6 | User 7 | User 8 |
|---|---|---|---|---|
| Medieval History (Non-Fiction) | X | X | | |
| Medieval Fiction | ? | X | X | X |
| Pirate History (Non-Fiction) | | | X | X |
| Pirate Fiction | X | X | | X |

In this context, since similar users (User 6, User 7, and User 8) have shown interest in books having the digital artifact property criteria “Medieval Fiction”, the second collaborative filtering engine will likely recommend books having the digital artifact property criteria “Medieval Fiction” to User 5.

Thus, where the second recommendation engine 320 is a second collaborative filtering engine, data about a particular one of the low-data users 304 (including input 322 received where the low-data-user 304 is a zero data user 316, as described below) is used to identify other users 323 of the system having similar proclivities or affinities, and then digital artifacts 312 having digital artifact property criteria 314 that were of interest to those similar users 323 can be recommended to the particular one of the low-data users 304.

After selection of the particular digital artifact property criteria 314, specific digital artifacts 310 meeting the digital artifact property criteria 314 can be selected by any suitable technique, including, for example and without limitation, a relevance score, a release time, popularity, and randomness. Thus, continuing the example, if “Medieval Fiction” is selected as the digital artifact property criteria, recommendations of digital artifacts satisfying that digital artifact property criteria (medieval fiction books) can be made.

For the zero-data users 316, in the illustrated embodiment the second recommendation engine 320 receives user input 322 from the zero-data users 316. The user input 322 is indicative of areas of interest, and the second recommendation engine 320 selects the digital artifact property criteria 314 for the zero-data users 316 according to the user input 322. Conceptually, once they have provided data, the zero-data users effectively become some-data users. The zero-data users 316 may be presented with a list of digital artifact property criteria from which to select, or the second recommendation engine 320 may derive digital artifact property criteria from user input. For example, in the case of digital books, the zero-data users 316 may be asked to identify books or authors that they have enjoyed, and the second recommendation engine 320 may derive digital artifact property criteria from the specified books or authors. More broadly, the second recommendation engine 320 may derive digital artifact property criteria from specific examples of digital artifacts, for example by matching one or more of the specific examples to a corresponding entry in an a database of digital artifacts.

Of note, in preferred embodiments, the first recommendation engine 308 directly selects individual digital artifacts 310 from among the plurality of digital artifacts 312 independently of digital artifact property criteria 314 used by the second recommendation engine 320.

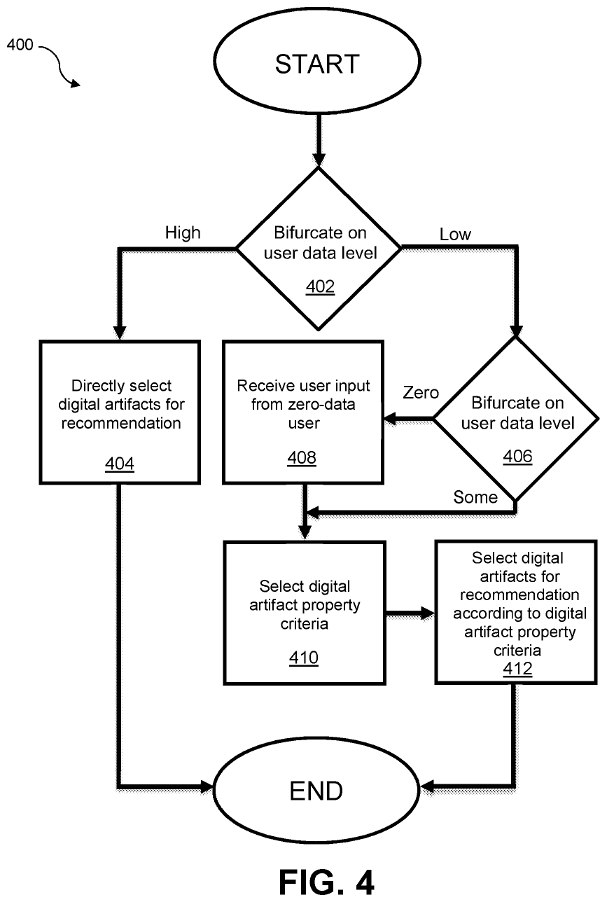

FIG. 4 is a flow chart 400 showing an embodiment of the method 300 shown in FIG. 3. At step 402, the method 400 bifurcates users into low-data users and high-data users. For the high-data users, the method 400 proceeds to step 404 where the method 400 directly selects individual ones of the digital artifacts for recommendation according to a first recommendation engine. In preferred embodiments, the first recommendation engine is a first collaborative filtering engine. For the low data users, the method 400 proceeds to step 406 to further bifurcate the low-data users into zero-data users and some-data users. Steps 402 and 406 may equivalently be combined; trifurcation into high-data users, some-data users and zero-data users is equivalent to two successive bifurcation steps. For the zero-data users, the method 400 proceeds to step 408 to receive user input from the zero-data users, and then to step 410. The user input received at step 408 is indicative of areas of interest for the respective zero-data users. For the some-data users, the method 400 proceeds directly to step 410.

At step 410, for the low-data users (both the some-data users and the zero-data users) the method 400 selects digital artifact property criteria, and then at step 412 the method 400 selects digital artifacts for recommendation from among those of the digital artifacts that satisfy the selected digital artifact property criteria. Thus, at steps 410 and 412, the method 400 indirectly selects individual ones of the digital artifacts for recommendation by first selecting a digital artifact property criteria and then selecting from among those of the digital artifacts that satisfy the selected digital artifact property criteria. For the some-data users, the accrued (limited) data is used to make inferences about the user's specific digital artifact preferences and thereby select the digital artifact property criteria. For the zero-data users, selecting the digital artifact property criteria is done according to the user input. In a preferred embodiment, the digital artifact property criteria may be selected using a second recommendation engine, which may be a second collaborative filtering engine that differs from the first collaborative filtering engine.

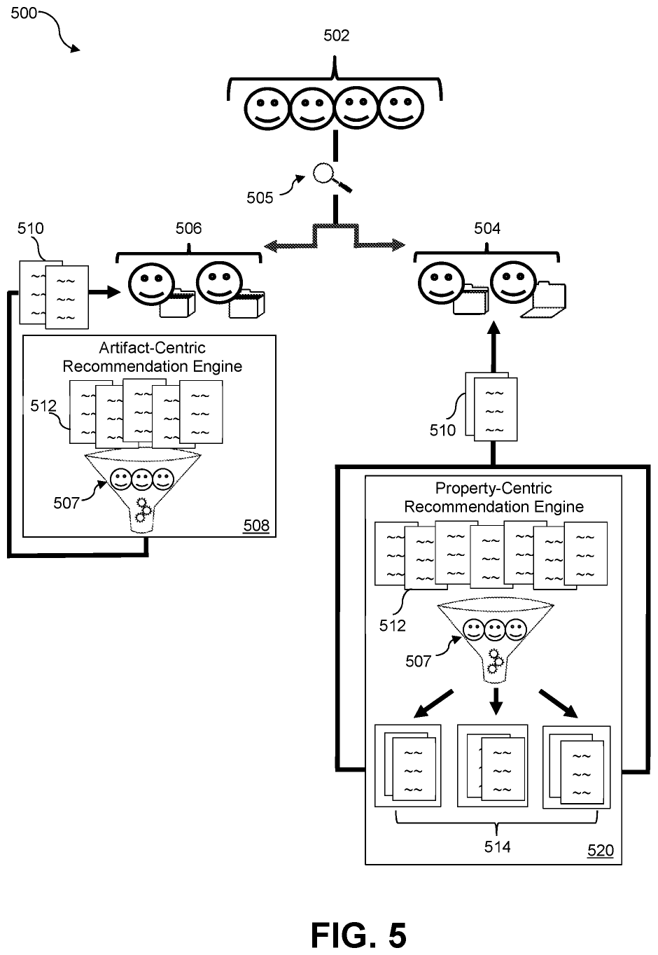

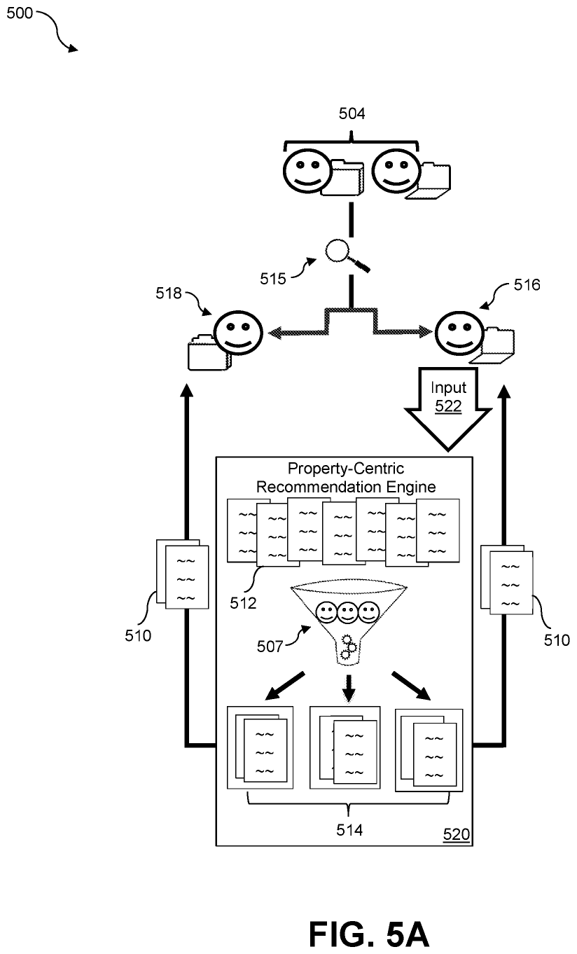

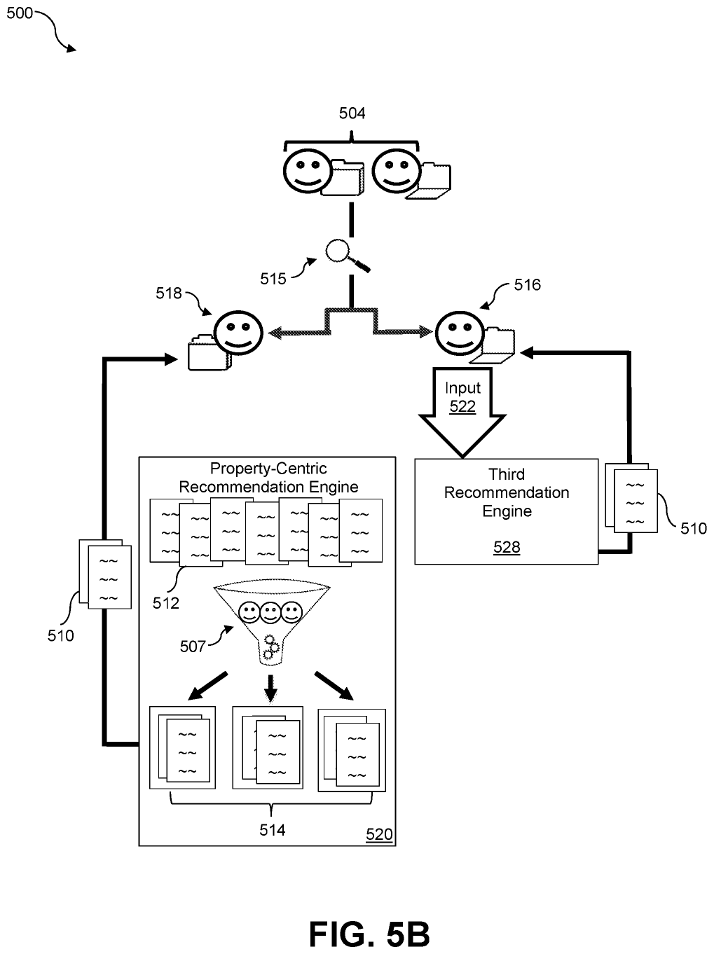

FIG. 5 shows a second illustrative embodiment of a computer-implemented method 500 for selecting digital artifacts for recommendation from amongst a plurality of digital artifacts. The method 500 identifies 505 one of the current users 502 as either an above-threshold user 506 who has consumed at least a threshold number of digital artifacts, or a below-threshold user 504 who has consumed fewer than the threshold number of digital artifacts.

Where the current user 502 is identified as an above-threshold user 506, the method 500 selects digital artifacts 510 for recommendation according to a first recommendation engine 508, which in the illustrated embodiment is an artifact-centric recommendation engine 508 that selects only individual digital artifacts, rather than first selecting properties of the digital artifacts and then selecting digital artifacts having those properties, the latter being considered “property-centric”. In a particularly preferred embodiment, the artifact-centric recommendation engine 508 deploys an artifact-centric collaborative filtering engine that selects the recommended digital artifacts 510 from among a plurality of digital artifacts 512 for recommendation by comparing the respective current user 502, in particular the respective above-threshold user 506, to similar prior users 507, for example as described above in the context of Table 1.

Where the current user 502 is identified 505 as a below-threshold user 504, the method 500 selects digital artifacts 510 for recommendation according to a second recommendation engine 520. The second recommendation engine 520 is different from the first recommendation engine 508 used to select digital artifacts to recommend to the above-threshold users 506. In a preferred embodiment, the second recommendation engine 520 is a property-centric recommendation engine 520 that first selects one or more properties 514 of the digital artifacts 512 and then recommends digital artifacts 510 having the selected one or more properties 514. For example, where the digital artifacts are books, for a particular below-threshold user 504 the second collaborative filtering engine identifies shared proclivities and affinities with other users, and will recommend to that particular user books having a digital artifact property 514 (e.g. “Medieval Fiction”) that was of interest to the other similar users, analogously to the discussion of Table 2 above.

FIG. 5A provides additional detail on a preferred embodiment of an aspect of the method 500 shown in FIG. 5, with respect to the below-threshold users 504 and the second recommendation engine 520. The method 500 further identifies 515 each of the below-threshold users 504 as either an empty user 516 who has consumed no digital artifacts, or a naïve user 518 who has consumed at least one digital artifact and fewer than the threshold number of digital artifacts. For each below-threshold user 504 who is identified 515 as an empty user 516, the property-centric recommendation engine receives user input 522 from the empty user 516, which is indicative of areas of interest to the empty user 516, and selects the digital artifact property criteria 514 according to the user input. For each below-threshold user 504 who is identified 515 as a naïve user 518, the property-centric recommendation engine 520 may deploy a property-centric collaborative filtering engine that selects digital artifact property criteria 514 by comparing the current below-threshold user 504 to similar prior users. For both the empty users 516 and the naïve users 518, the property-centric recommendation engine 520 selects digital artifacts 510 for recommendation from amongst a set of digital artifacts 512 satisfying the selected digital artifact property criteria 514. The selection may be according to one or more of a relevance score, a release time, popularity, and randomness, among other criteria.

It is contemplated that the selection mechanics within the second recommendation engine 520 may differ for the naïve users 518 and the empty users 516. FIG. 5B shows a modified form of the arrangement shown in FIG. 5A in which selecting the digital artifact property criteria according to the user input 522, and selecting the digital artifacts 510 for recommendation, is done by a third recommendation engine 528. The third recommendation engine 528 may be, for example, a collaborative filtering engine.

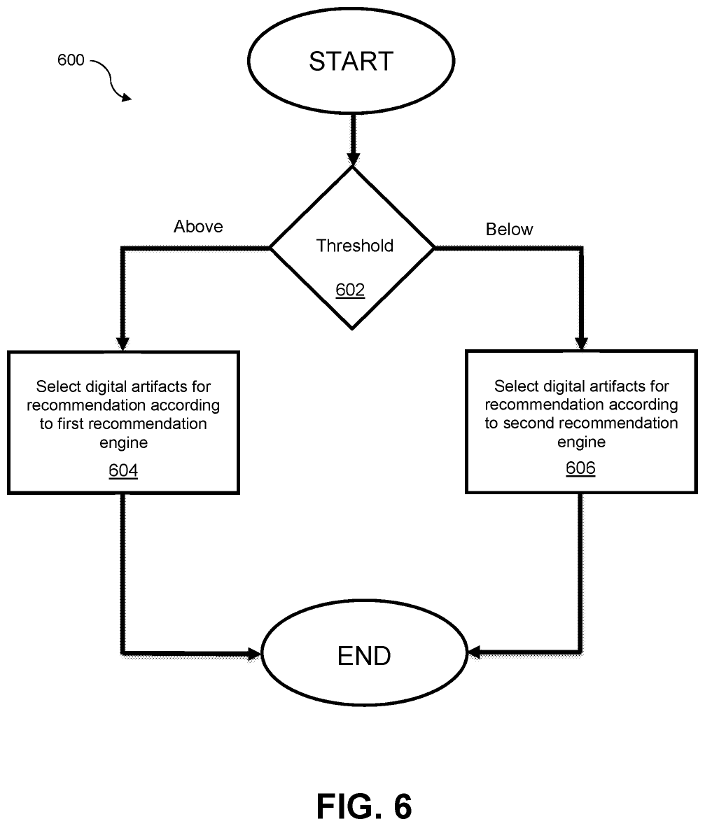

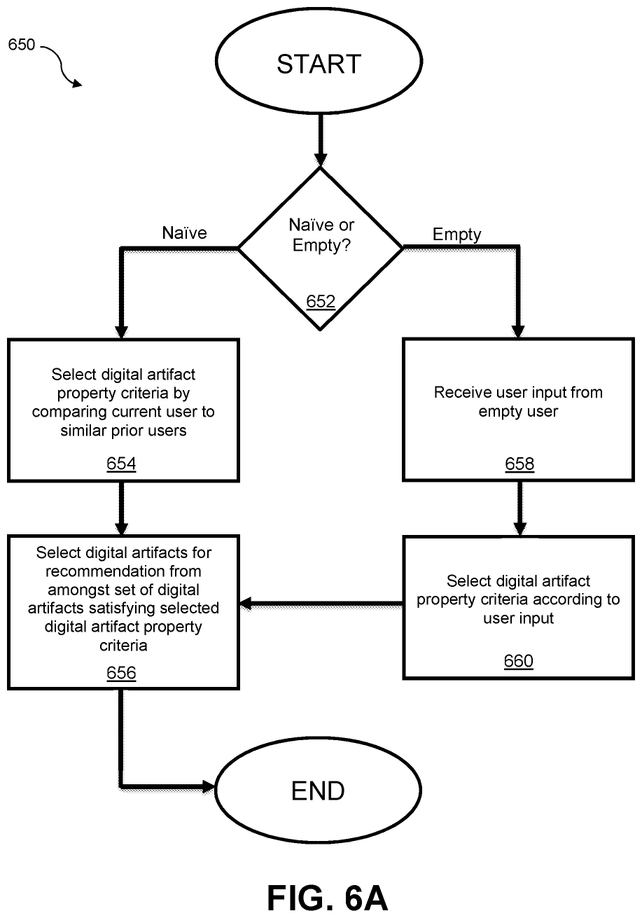

Reference is now made to FIG. 6, which is a flow chart 600 showing an embodiment of the second illustrative computer-implemented method 500 (FIG. 5) for selecting digital artifacts for recommendation from amongst a plurality of digital artifacts. At step 602, the method identifies a current user as either an above-threshold user who has consumed at least a threshold number of digital artifacts, or a below-threshold user who has consumed fewer than the threshold number of digital artifacts. Where the current user is identified as an above-threshold user at step 602, the method proceeds to step 604 to select digital artifacts for recommendation according to a first recommendation engine. In a preferred embodiment, the first recommendation engine is an artifact-centric recommendation engine that selects only individual digital artifacts, rather than first selecting properties of the digital artifacts and then selecting digital artifacts having those properties, the latter being considered “property-centric” as noted above. In a particularly preferred embodiment, the artifact-centric recommendation engine deploys an artifact-centric collaborative filtering engine that selects the digital artifacts for recommendation by comparing the current user to similar prior users. For example, where the digital artifacts are books, data about a particular user is leveraged to identify other users of the system having similar proclivities or affinities, and then books (e.g. “Basic Economics”) that were of interest to those similar users can be recommended to the particular user, analogously to the discussion of Table 1 above.

Where the current user is identified at step 602 as a below-threshold user who has consumed fewer than the threshold number of digital artifacts, the method proceeds to step 606 to select digital artifacts for recommendation according to a second recommendation engine that is different from the first recommendation engine used at step 604. In a preferred embodiment, the second recommendation engine is a property-centric recommendation engine that first selects one or more properties of the digital artifacts and then selects digital artifacts having the selected one or more properties. In a particularly preferred embodiment, the property-centric recommendation engine deploys a property-centric collaborative filtering engine that selects the digital artifacts for recommendation by comparing the current user to similar prior users. For example, for a particular user shared proclivities and affinities with other users are identified and used to recommend to that particular user books having a digital artifact property (e.g. “Medieval Fiction”) that was of interest to the other similar users, analogously to the discussion of Table 2 above.

Reference is now made to FIG. 6A, which shows an illustrative non-limiting method 650 for selecting digital artifacts for recommendation by a property-centric recommendation engine. The method 650 is thus a non-limiting illustrative implementation of step 606 of the method 600 shown in FIG. 6.

At step 652, the method 650 further identifies each current user who was identified at step 602 (FIG. 6) of the method 600 (FIG. 6) as a below-threshold user as either a naïve user who has consumed at least one digital artifact but fewer than the threshold number of digital artifacts, or an empty user who has consumed no digital artifacts. For each current user who is identified as a naïve user at step 652, the method 650 proceeds to step 654, where the property-centric recommendation engine deploys a property-centric collaborative filtering engine that selects digital artifact property criteria by comparing the current user to similar prior users. In one embodiment, the property-centric collaborative filtering engine compares the current user to all other users for which there is some data (both other naïve users and also above-threshold users). In another embodiment, the property-centric collaborative filtering engine compares the current user only to other naïve users. The method 650 then proceeds to step 656, where the property-centric collaborative filtering engine selects digital artifacts for recommendation from amongst a set of digital artifacts satisfying the selected digital artifact property criteria. The selection at step 656 may be according to one or more of a relevance score, a release time, popularity, and randomness, among other criteria.

For each current user who is identified as an empty user at step 652, the method 650 proceeds to step 658 where the property-centric recommendation engine receives user input from the empty user, and then to step 660 where the property-centric recommendation engine selects the digital artifact property criteria according to the user input. The user input is indicative of areas of interest to the empty user. After the property-centric recommendation engine selects the digital artifact property criteria at step 660, the method 650 proceeds to step 656, where the property-centric recommendation engine deploys the property-centric collaborative filtering engine to select digital artifacts for recommendation from amongst a set of digital artifacts satisfying the selected digital artifact property criteria.

As noted above, properties of digital artifacts may include conceptual “topic” annotations; these “topic” annotations may be used as digital artifact property criteria. In some embodiments, the “topic” annotations may be added manually, although this is labour intensive. In preferred embodiments, the digital artifact property criteria is a topic determined by Latent Dirichlet Allocation (LDA) topic modeling. Of note, titles are particularly useful for topic modeling where content is not easily parsed, such as audio and video content, as these materials will still typically have a title. Optionally, voice activity detection and/or image classifiers could be used to facilitate parsing of audio and video/image content for topic modeling, but this imposes additional computational cost. Similarly, while the full content of textual digital artifacts like articles and books can be parsed using LDA modeling, there are increased computational costs here as well, so that there are advantages to using titles for topic modeling. LDA topic modeling may be implemented using, for example, the Python package “nltk” (available at https://github.com/nltk/nltk).

A range of different recommendation models may be used, including collaborative filtering (as noted above) and content-based filtering, or a hybrid approach that combines collaborative filtering and content-based filtering, among others. Content-based filtering may be used in circumstances where it is feasible (both from a technical perspective and a privacy protection perspective) to gather the information required to establish the user profile upon which content-based filtering relies. However, where it is less feasible (or infeasible) to gather this information, collaborative filtering is preferred because it requires only the identities of the users and of the digital artifacts with which they have engaged, and can avoid gathering of personal information. Thus, collaborative filtering is particularly preferred in both sparse data contexts and in privacy-centric contexts. Collaborative filtering is also beneficial as it may decrease the complexity and increase the speed of data preprocessing. Moreover, because collaborative filtering is not focused heavily on a user's previous choices, it can be flexible in its recommendations. The level of engagement can also be taken into account; for example where a user engages with a digital artifact more than once, this can be given additional weight, and the duration of engagement can also be considered.

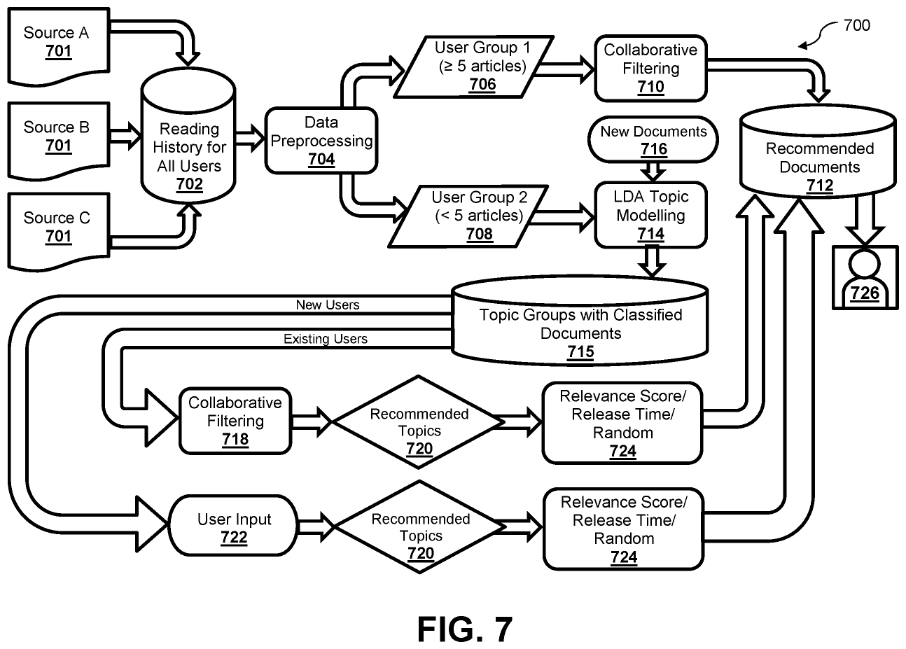

Reference is now made to FIG. 7, which shows a non-limiting illustrative process flow diagram for recommendation of digital artifacts according to an aspect of the present disclosure. The process flow 700 shown in FIG. 7 is suitable for digital artifacts that can be read, such as articles, books or other documents, and receives a user's reading history data as input and then outputs a list of recommended documents for that user.

The reading history data for all the users is stored in a prepared database 702 in which data is aggregated from multiple sources 701. The data is then preprocessed 704, and then examined and the users are classified into two groups:
(1) A first group 706 of users who have read at least five documents in total (labeled as “User Group 1” in FIG. 7); and
(2) A second group 708 of users who have read fewer than five documents in total (labeled as “User Group 2” in FIG. 7).
   Thus, the first group 706 of users (User Group 1) are “high-data users” 306 (FIG. 3) and “above-threshold users” 506 (FIG. 5) with the threshold being five (5), and similarly the second group 708 of users (User Group 2) are “low-data users” 304 (FIG. 3) and “below-threshold users” 504 (FIG. 5). The threshold of five (5) is merely illustrative, and not limiting. Reference to having read a certain number of documents refers, in this context, to having accessed those documents for reading purposes through the relevant system.

For the first group 706 of users (User Group 1), the preprocessed data is fed directly into a neural network based collaborative filtering model 710 which enables generation of a list of recommended documents 712 for users within the first group 706 of users (User Group 1).

For the second group 708 of users (User Group 2), the preprocessed data is fed into an LDA topic modelling model 714 which classifies each document according to its predominant topic group and this data is stored in a database 715 of topic groups with classified documents. New documents 716 that have not been read by any users are also classified into the most relevant topic group and stored in the same database 715 of topic groups with classified documents. Then, for users who have some existing reading history (“Existing Users” in FIG. 7), instead of recommending specific documents, collaborative filtering 718 is used to generate a list of recommended topics 720. For users who do not have any reading history (“New Users” in FIG. 7), user input 722 is used to generate the list of recommended topics 720. For example, the New Users may be asked to select one or more topics of interest. After generating the list of recommended topics 720, documents satisfying those topics can be selected 724 by one or more of relevance score, release time or randomness (among other criteria), and the selected documents can be placed in the list of recommended documents 712 for the respective users 726.

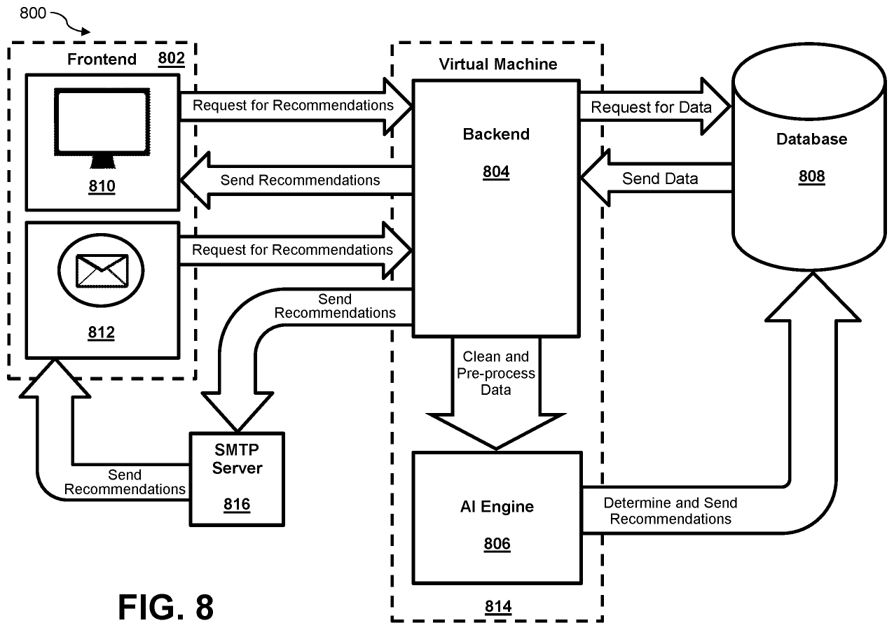

Reference is now made to FIG. 8, which is a block diagram showing an illustrative architecture for an embodiment of a system 800 for selecting digital artifacts for recommendation from amongst a plurality of digital artifacts according to an aspect of the present disclosure.

The system 800 comprises a frontend 802, a backend 804, an artificial intelligence (AI) engine 806 and a database 808. The frontend 802 may include a web interface 810 and/or an e-mail interface 812. For example, the web interface 810 may comprise a customer facing web browser extension (e.g. accessible via an app store such as the Google Chrome web store). The web browser extension may be for a desktop computer, or for a mobile device, such as a smartphone or tablet using a mobile version of a web browser, for example Safari Mobile for iOS or Chrome for Android, among others. Both the web interface 810 and the e-mail interface 812 may be implemented using JavaScript, for example. The backend 804 and AI engine 806 may be implemented on a virtual machine (VM) 814, which may execute on one of the servers 108 in the data center 106 (FIG. 1).

In one embodiment, the backend 804 implements an Application Programming Interface (API) which receives requests for recommendations from the frontend 802 (web interface 810 and/or e-mail interface 812) and returns recommendations and optionally links to the recommended digital artifacts; this may be done, for example, using JavaScript Object Notation (JSON). Where recommendations are to be provided to the e-mail interface 812, the backend 804 may send recommendations to a Simple Mail Transfer Protocol (SMTP) server 816, which can then transmit the recommendation via e-mail to the e-mail interface 812. The backend 804 also cleans and preprocesses data (for example, user engagement with digital artifacts) and passes the cleaned and preprocessed data to the AI engine 806. In one embodiment, the backend 804 may be implemented, for example, using Flask, which is a web framework implemented in Python (an earlier version is available at https://flask.palletsprojects.com/en/2.2.x/ and the latest stable version at time of filing is available at https://flask.palletsprojects.com/en/2.3.x/). In addition, the backend 804 communicates with the database 808 to request and obtain data for the recommendations. In one embodiment, the database 808 may be implemented using an object-relational database, such as PostgreSQL (available at https://www.postgresql.org).

The AI engine 806 receives the cleaned and preprocessed data from the backend 804 and determines and sends recommendations to the database 808. In one embodiment, the AI engine 806 is implemented using Fast.ai (available at https://docs.fast.ai/). Fast.ai is PyTorch software that can be used to build and train neural network recommendation engines. This is merely an illustrative, non-limiting example. Detailed mathematical implementation of machine learning techniques suitable for implementation of the present technology, including neural networks, recommendation engines (including collaborative filtering, content-based filtering, and hybrid filtering), and LDA topic modeling, are within the capability of one of ordinary skill in the art, now informed by the present disclosure, and are not discussed further.

The above architecture is merely one illustrative embodiment, and is not intended to be limiting.

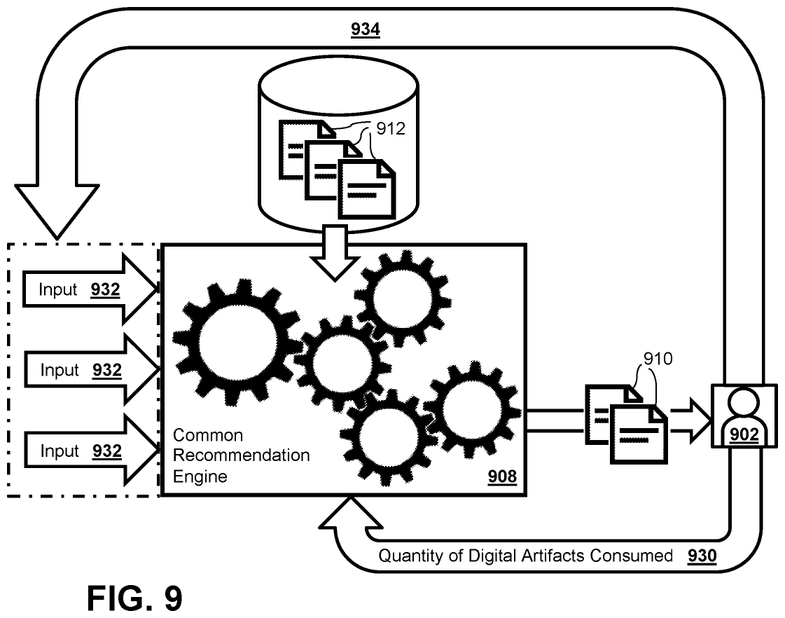

The foregoing examples describe embodiments in which there are explicit procedural distinctions amongst different types of users based on the amount of relevant data available for those users, measured by way of the number of digital artifacts consumed by the user. In the method 300 shown in FIG. 3, for example, there are explicit distinctions between low-data users 304 and high-data users 306, and within the low-data users 304 there are further explicit distinctions between zero-data users 316 and some-data users 318. Similarly, in the method 500 shown in FIG. 5, there are explicit distinctions between above-threshold users 506 and below-threshold users 504, the latter of whom may in the method 500 be further explicitly distinguished as naïve users 516 and empty users 516. In other embodiments, however, the amount of relevant data available for the users, for example as measured by way of the number of digital artifacts consumed by the user, may be taken into account implicitly. A machine learning model may be trained using training data that includes various inputs that are potentially relevant to user preferences in respect of digital artifacts, with one of the inputs being the quantity of digital artifacts consumed or otherwise engaged with by the respective user. As shown in FIG. 9, the trained machine learning model may then be used as a common recommendation engine 908 that can select, for a particular user 902, digital artifacts 910 for recommendation from amongst a plurality of digital artifacts 912, with the quantity of digital artifacts already consumed by that particular user 902 being an input 930 to the common recommendation engine 908, optionally along with other inputs 932, which may also originate 934 with the user 902.

Where machine learning is used, any of the models described herein can be configured to receive user feedback about the accuracy of the recommendations, which can then be input into the model to improve accuracy (e.g. modify the loss function).

As can be seen from the above description, the content recommendation technology described herein represents significantly more than merely using categories to organize, store and transmit information and organizing information through mathematical correlations. The content recommendation technology is in fact an improvement to artificial intelligence applications within the content recommendation space, as it adapts artificial intelligence to accommodate scenarios where there is some information about a user's preferences but not enough for sufficiently accurate recommendation of individual digital artifacts. The present technology therefore represents a specific solution to a computer-related problem. As such, the content recommendation technology is confined to artificial intelligence as specifically applied to content recommendation, and is of particular application to machine learning.

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, RAM (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a training data set” or “the training data set” does not exclude embodiments in which multiple training data sets are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A computer-implemented method for selecting digital artifacts for recommendation from amongst a plurality of digital artifacts, the method comprising:
identifying a current user as one of:
an above-threshold user who has consumed at least a threshold number of digital artifacts; and
a below-threshold user who has consumed fewer than the threshold number of digital artifacts;
where the current user is identified as being an above-threshold user, selecting digital artifacts for recommendation according to a first recommendation engine; and
where the current user is identified as being a below-threshold user, selecting digital artifacts for recommendation according to a second recommendation engine.

2. The method of claim 1, wherein:
the first recommendation engine is an artifact-centric recommendation engine; and
the second recommendation engine is a property-centric recommendation engine.

3. The method of claim 2, wherein the artifact-centric recommendation engine deploys an artifact-centric collaborative filtering engine that selects the digital artifacts for recommendation by comparing the current user to similar prior users.

4. The method of claim 2, wherein:
the property-centric recommendation engine further identifies each current user who was identified as a below-threshold user as one of:
an empty user who has consumed no digital artifacts; and
a naïve user who has consumed at least one digital artifact and fewer than the threshold number of digital artifacts; and
for each current user who is identified as being a naïve user, the property-centric recommendation engine deploys a property-centric collaborative filtering engine that selects digital artifact property criteria by comparing the current user to similar prior users.

5. The method of claim 4, wherein for each current user who is identified as being an empty user, the property-centric recommendation engine:
receives user input from the empty user wherein the user input is indicative of areas of interest to the empty user; and
selects the digital artifact property criteria according to the user input.

6. The method of claim 4, wherein the property-centric recommendation engine selects the digital artifacts for recommendation from amongst a set of digital artifacts satisfying the selected digital artifact property criteria according to at least one of a relevance score, a release time, or randomness.

7. The method of claim 4, wherein the digital artifact property criteria comprises a topic determined by Latent Dirichlet Allocation (LDA) topic modeling.

8. A data processing system comprising at least one processor and memory coupled to the at least one processor, wherein the memory contains instructions which, when implemented by the at least one processor, cause the at least one processor to implement the method of claim 1.

9. A non-transitory, tangible computer-readable medium embodying instructions which, when implemented by at least one processor of a data processing system, cause the data processing system to implement the method of claim 1.

10. A computer-implemented method for selecting digital artifacts for recommendation from amongst a plurality of digital artifacts, the method comprising:
bifurcating users into low-data users and high-data users;
for the high-data users, directly selecting individual ones of the digital artifacts for recommendation according to a first recommendation engine; and
for the low-data users, indirectly selecting individual ones of the digital artifacts for recommendation by first selecting digital artifact property criteria and then selecting from among those of the digital artifacts that satisfy the selected digital artifact property criteria.

11. The method of claim 10, wherein the first recommendation engine is a first collaborative filtering engine.

12. The method of claim 10, further comprising:
further bifurcating the low-data users into zero-data users and some-data users; and
for the some-data users, selecting the digital artifact property criteria using a second recommendation engine.

13. The method of claim 12, wherein the second recommendation engine is a second collaborative filtering engine.

14. The method of claim 12, further comprising:
for the zero-data users, receiving user input from the zero-data users wherein the user input is indicative of areas of interest; and
selecting the digital artifact property criteria according to the user input.

15. The method of claim 12, wherein selecting the digital artifact property criteria according to the user input is done by a third recommendation engine.

16. A data processing system comprising at least one processor and memory coupled to the at least one processor, wherein the memory contains instructions which, when implemented by the at least one processor, cause the at least one processor to implement the method of claim 10.

17. A non-transitory, tangible computer-readable medium embodying instructions which, when implemented by at least one processor of a data processing system, cause the data processing system to implement the method of claim 10.

18. A computer-implemented method for recommending digital artifacts from amongst a plurality of digital artifacts, the method comprising:
selecting, for a particular user, digital artifacts for recommendation according to a common recommendation engine;
wherein a quantity of digital artifacts consumed by the user is an input to the common recommendation engine.

19. A data processing system comprising at least one processor and memory coupled to the at least one processor, wherein the memory contains instructions which, when implemented by the at least one processor, cause the at least one processor to implement the method of claim 18.

20. A non-transitory, tangible computer-readable medium embodying instructions which, when implemented by at least one processor of a data processing system, cause the data processing system to implement the method of claim 18.
